(19) United States
(12) Patent Application Publication
(10) Pub. No.: US 2024/0293823 A1
(43) Pub. Date: Sep. 5, 2024

(54) WELL CARRIER DEVICE FOR A DISPENSING DEVICE

(71) Applicant: DISPENDIX GMBH, Stuttgart (DE)

(72) Inventors: Braun CHIARA, Stuttgart (DE); Stefan BAMMESBERGER, Stuttgart (DE)

(21) Appl. No.: 18/573,128

(22) PCT Filed: Jun. 24, 2022
(86) PCT No.: PCT/EP2022/067370

§ 371 Date: Dec. 21, 2023

(30) Foreign Application Priority Data
Jun. 26, 2021 (LU) LU500336

(51) Int. Cl. B01L 9/06; G01N 35/04

(52) U.S. Cl. CPC B01L 9/06; G01N 35/04; B01L 2300/0803; G01N 2035/0441

(57) ABSTRACT

The invention relates to a well carrier device for a dispensing device for dispensing a liquid sample, with a well carrier that comprises a coupling means for connecting with a rotating drive of the dispensing device in a rotationally fixed manner. The well carrier device is characterized in that the well carrier device comprises at least one holder element for holding at least one well for receiving a liquid sample, wherein the holder element is detachably connected to the well carrier.

The invention relates to a well carrier device for a dispensing device for dispensing a liquid sample, with a well carrier that comprises a coupling means for connecting with a rotating drive of the dispensing device in a rotationally fixed manner. Additionally, the invention relates to a dispensing device for dispensing a liquid sample with such a well carrier device.

Dispensing devices for dispensing fluids are already known. Said dispensing devices can use either air pressure or positive displacement to dispense fluids in a controlled way. Air pressure-based dispensing devices use air pressure that is outputted by an air compressor or a similar device and push on a piston or piston-like component that in turn push a fluid in a barrel out of the nozzle. Positive displacement dispensing devices on the other hand do not use compressed air. They usually push a piston inside a barrel by means of a mechanical force that can be generated by electric stepper motors. They are ideal for instance for fluids that change viscosity over time generally and for precise control of flow rate and volume of the dispensed fluid.

A dispensing device is known that comprises a dispensing head used for dispensing a liquid sample located in a well. The dispensing device is configured such that liquid sample is dispensed from the well. The well is carried by a well carrier that is arranged in a receiving means of the dispensing device and has a circular cross section. The well carrier is connected with a driving unit of the dispensing device and can be rotated between different positions, in particular between a dispensing position and an insertion position. The well can be inserted into a receiving portion of the well carrier in a detachable manner. In the receiving portion only a part comprising the receiving portion protrudes from a housing of the dispensing device. After inserting the well into the receiving portion the well carrier is rotated in the dispensing position and the liquid sample is dispensed by the dispensing head into a target carrier that is arranged below the well carrier.

After a dispensing process the well carrier is rotated back into the insertion position. If the user wants to use the same well for a further dispensing process the user refills the well with the liquid sample. However, the receiving portion and thus, the well only protrudes slightly from the housing of the dispensing device so that the refill process is cumbersome and time consuming. Additionally, the housing makes the well change difficult if the user has to detach the well if e.g. another liquid sample shall be dispensed.

The object of the invention is to provide a well carrier device by means of which the refill process and the well exchange can be easily made and do not require much time.

The object is solved by a well carrier device as mentioned above that is characterized in that the well carrier device comprises at least one holder element for holding at least one well for receiving a liquid sample, wherein the holder element is detachably connected to the well carrier.

The inventive well carrier device has the advantage that a holder element is provided that is detachably connected to the well carrier. This has the advantage that the holder element can be detached from the well carrier when a liquid sample shall be refilled and/or when the well shall be replaced from the well carrier. Thus, a housing of the dispensing device does not hinder refilling or a well change so that the refill and/or exchange process is less cumbersome and less time consuming than in the embodiment discussed above.

As “detachably connected” it is understood that the holder element can be detached from the well carrier without destroying the holder element and/or the well carrier. After the holder element is detached it is possible to connect the holder element again to the well carrier.

A well is a fluid reservoir with a hole at its bottom. The well is capable of holding and releasing a liquid sample onto a target plate only when a well-defined pressure pulse is applied on top of the well. When there is no pressure pulse applied on the well, no liquid sample is released since capillary forces keep the liquid sample in the well. That means, no liquid sample is released from the well due to the atmosphere pressure acting on the liquid sample. The dispensing device is configured to apply a pressure on the liquid sample arranged in the well so that liquid sample is dispensed from the well.

A well can be made out of polymers (e.g., polypropylene), metals (e.g., aluminium, copper) and/or glass. When a pressure pulse is applied on top of the well a droplet is released on a target carrier arranged below the well. The target carrier is arranged in a receive portion of the dispensing device. Additionally, the target carrier is arranged such that the liquid sample dispensed from the well falls into the target carrier, in particular in a receptacle of the target carrier. To hit different spots on the target carrier, the target carrier can be moved horizontally in all directions.

The hole of the well can have a diameter between 60 μm (micrometre) and 200 μm, in particular 100 μm. The dispensed liquid sample can be a droplet and/or have a volume of at least 10 nanoliters. Larger volumes are achieved by applying up to 100 pulses per second on the well. The maximum volume of the dispensed liquid per well is the well volume. The well can have a volume between 80 microliters to 500 microliters.

The liquid sample depends on the usage field of the dispensing device. The liquid sample can contain a liquid and at least one biological particle. The biological particles may be microorganisms such as bacteria, archaean, yeast, fungi, and viruses or cells, DNA, RNA, or proteins. The liquid sample may have a single or multiple of the aforementioned biological particles. The liquid can promote the growth of the biological particles, in particular cells, arranged in the liquid. Alternatively, the liquid sample can comprise merely liquids, e.g. one or more chemical reagents.

The holder element can be any component that is capable to hold a well. As is explained below the holder element can be configured to hold several wells.

According to an embodiment of the invention the well carrier device can be disc shaped. Additionally, the well carrier device can have a circular shape in cross section. Such a well carrier device has the advantage that it is compact resulting in a compact receiving space in the dispensing device.

The connection between the well carrier and the holder element can be made such that the holder element can be tool free detached from the well carrier. That means, no tools has to be used to detach the holder element from the well carrier. Likewise, no tools are needed to connect the holder element to the well carrier.

The well carrier can have a connecting portion for connecting with the holder element, wherein the connecting portion can be arranged at the edge of the well carrier and/or the connecting portion extends along a part of the circumference of the well carrier. “Edge” means the rim portion of the well carrier in radial direction with respect to a rotation axis of the well carrier. Such connecting portion has the advantage that the holder element can be easily detached form the well carrier. In particular, it is possible to easily detach the holder element from the well carrier when the well carrier device is arranged in an insertion position. In said position at least a part of the holder element protrudes from a housing of the dispensing device so that a user can easily grasp the holder element.

An extension of the connecting portion in axial direction can be smaller than an extension of the remaining part of the well carrier. This enables that in connected state of the holder element with the well carrier an upper side of the holder element is flush with an upper side of the well carrier and/or a lower side of the holder element is flush with a lower side of the well carrier. Such a well carrier device has a compact structure in axial direction.

The direction indications “axial”, “tangential” and “radial” used in this application refer to a rotation axis of the well carrier device. The well carrier device is rotated along the rotation axis when it is inserted in the dispensing device.

The well carrier, in particular the connecting portion, comprises at least one magnet for magnetically connecting the holder element to the well carrier. In particular, the well carrier, comprises more, in particular, two magnets that are arranged at the ends of the connecting portion, respectively. Thus, it is possible to detach the holder element from the well carrier or to attach the holder element to the well carrier in a simple way without performing further working steps.

The coupling means is a portion that is configured to provide mechanical connection between the well carrier device and the rotating device of the dispensing device. The rotating device can comprise a motor and is used to rotate the well carrier device in different positions as it is discussed below. The coupling can be a frictional connection or a positive connection.

According to an embodiment the well carrier can comprise at least one opening for receiving a fixing means of the dispensing device during a dispensing process. The well carrier device has to be fixed during the dispensing process in order to secure that a dispensing line of a dispensing head can be arranged fluid-tight on the well. The fluid-tight arrangement is necessary in order to secure that a droplet with a predetermined volume can be dispensed from the well.

The number of openings corresponds with the number of wells that can be attached to the holder element. Each opening can be assigned to one well. Thus, it is possible to fix the well carrier device independent on the position of the well carrier device, i.e. independent which well is used in the dispensing process.

According to an embodiment the well carrier can comprise at least one lighting means. The lighting means can be arranged and/or orientated such that it lightens the holder element. In particular, the lighting means is used to lighten the well during a dispensing process. Thus, the dispensing process can be well observed and/or monitored. Alternatively or additionally, the lighting means lightens the well after a dispensing process. In particular, the lighting means lightens the well when the well carrier device is rotated in a position in which the wells are visible for a user, e.g. when the well carrier device is rotated in an insertion position.

The lighting means can be arranged at a front face of the connecting portion. The front face of the connecting portion corresponds to the surface of the connecting portion that faces the well or wells when the holder element is connected to the well carrier. Additionally, the front face correspond with the outer rim of the connecting portion. The number of lighting means can corresponds with the number of wells that can be attached to the holder element. Thus, it is possible to observe and/or monitor each well during the dispensing process.

According to an embodiment the holder element can be arc-shaped and/or hold several wells. Holding several wells increases the efficiency of the dispensing process as the user does not have to refill or exchange the well after each dispensing process.

The holder element can be formed such that it does not cover a well bottom, in particular a hole arranged at the well bottom. Thus, it is possible that liquid sample is released from the well without being hindered by the holder element. That means, the released liquid samples falls into a target carrier arranged below the well carrier device without being hindered by the holder element, in particular a lower plate of the holder element.

The holder element can have a holding portion for holding a well or can have several holding portions for holding a well, respectively. The holding portion is designed such that the well is insertable from an axial direction and/or a radial direction into the holding portion. In particular, the holder element can be inserted into the holding portion selectively along the axial direction or the radial direction. The holding portions can be arranged offset to each other, in particular along an arc line. The holding portion can comprise a u-shape in cross section. In the end, the holding portion enables that the well can be attached in a simple way to the holder element even if the holder element remains attached to the well carrier.

The holder element can have an upper plate and a lower plate that are arranged offset to each other. Both plates can be arranged in axial direction offset to each other. Additionally, both plates can have an arc shape and/or can be identically formed. Both plates have recesses for receiving one well, respectively. Said recesses are part of the holding portion. In a cross section comprising a plane orthogonal to the axial direction, the recesses can have a u-shape.

The upper plate and the lower plate can be connected with each other by means of at least two bars. A bar extends in axial direction and is connected at one end with the upper plate and at another end with the lower end. Both bars are identically built. The upper plate and lower plate can run parallel to each other, i.e. the axial distance between the upper and lower plate remains constant and/or a plane comprising the upper plate and a plane comprising the lower plate exist that are parallel to each other.

The bar can comprise at least one magnet for magnetically connecting the holder element to the well carrier. The holder element can be directly connected with the well carrier. In particular, the holder element can be directly connected with the well carrier by means of the magnets of the holder element and of the well carrier.

The holder element can be formed such that it is connectable with the well carrier by moving it in radial direction. In particular, the holder element and/or the well carrier can be formed such that it is only possible to attach the holder element to the well carrier or to detach the holder element from the well carrier by moving the holder element in radial direction. The radial direction for attaching the holder element to the well carrier is opposite to the radial direction for detaching the holder element from the well carrier.

The well carrier device can be designed such that several holder elements each holding one or more wells can be attached to the well carrier or detached from the well carrier. Each holder element can be attached to the well carrier or detached from the well carrier independent of the other holder elements. The holder elements can be formed identically to the holder element discussed above.

The well carrier device, in particular the well carrier, can comprise at least one sensor for, in particular automatically, sensing whether the holder element is attached to the well carrier. If the holder element is not attached to the well carrier, a control unit can prevent that the well carrier is rotated when it is inserted into the dispensing device.

Additionally, the well carrier device, in particular the well carrier, can comprise at least one sensor for, in particular automatically, sensing whether a well is inserted in a holding portion of the holder element. Such a sensor has the advantage that the well carrier device can automatically be rotated into a position in which the dispensing head can be brought in contact with a well. That means, the well carrier device will not be rotated to a position in which no well is arranged below a dispensing head.

A particularly advantageous dispensing device for dispensing a liquid sample arranged in a well comprises a well carrier device as discussed above. Additionally, the dispensing device comprises a rotating drive that is connected with the well carrier device in a rotationally fixed manner. Thus, the rotating drive sets the position of the well carrier device by rotating the well carrier device. Moreover, the dispensing device comprises a dispensing head for dispensing liquid sample located in a well of the well carrier device.

As a connection in a rotationally fixed manner, a connection is understood that secures that the well carrier device is rotated when the rotating drive rotates. In particular, both parts rotate in the same direction due to the rotationally fixed connection.

The dispensing head can have dispensing lines that in a dispensing process are arranged on the well in a fluid tight manner. Additionally, the dispensing head is configured such that it applies a pressure on the liquid sample in the well held by the holder element in order to dispense liquid sample from the well. The dispensing head, in particular the dispensing line, is configured such that it does not come into contact with liquid sample during the dispensing process, in which liquid sample is dispensed from the well.

The dispensing device can have a plate with a receiving. The receiving is a plate recess and used for receiving the well carrier device. The receiving has a front opening. The front opening is formed such that the well carrier device protrudes from the receiving opening when the well carrier device is arranged in the receiving of the plate. The well carrier device, in particular the holder element extends through the front opening when the well carrier device is arranged in the insertion position.

The dispensing device can comprise a control unit that controls the rotating drive such that the well carrier device can be, in particular selectively, rotated in an insertion position or a dispensing position or a parking position. In the insertion portion the holder element can be removed from the well carrier or connected with the well carrier. In the dispensing position the dispensing head can dispense a liquid sample located in the well held by the holding element. In the parking position the holder element is arranged within a housing of the dispensing device. Thus, in the parking position a contamination of the liquid sample located in the well or wells by dust or other materials is easily prevented.

Additionally, the control unit can control the rotating drive such that the well carrier device can be rotated in different filling positions. A filing position is a position in which the well to be filled is located centrally outside the device. In the filing position the respective well protrudes furthest from the housing of the dispensing device. Thus, the well can be easily filled. Each of the wells of the holder element can be rotated into a filling position.

The dispensing device can comprise a fixing means which protrudes in the opening of the well carrier during a dispensing process. The fixing means can be a pin that is arranged in the dispensing head.

The holder element can be connected to the well carrier or detachable from the well carrier when the well carrier is arranged in the receiving of the dispensing device. Thus, the connection or detaching of the holder element can occur without the need to have an access to the interior of the dispensing device. In particular, it is not necessary to open a housing of the dispensing device to have a better access to the wells holded by the well carrier device.

Particularly advantageous is the use of a well carrier device as described in a dispensing device for dispensing liquid.

In the figures, the subject-matter of the invention is schematically shown, wherein identical or similarly acting elements are usually provided with the same reference signs.

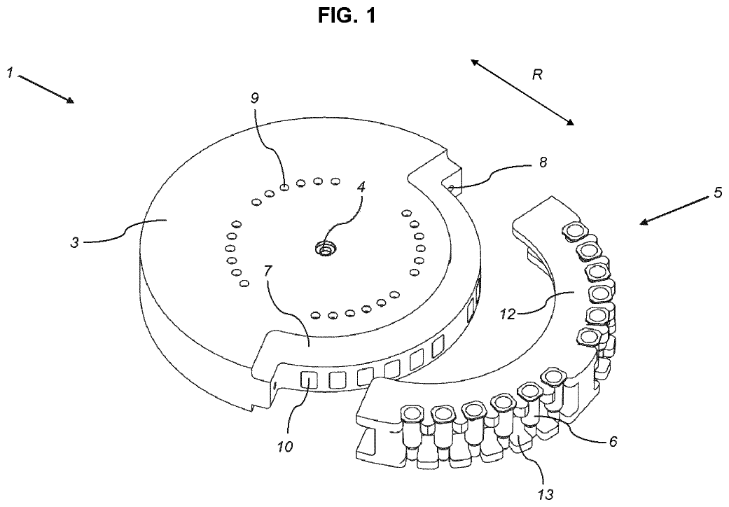

FIG. 1 a perspective view of the well carrier device,

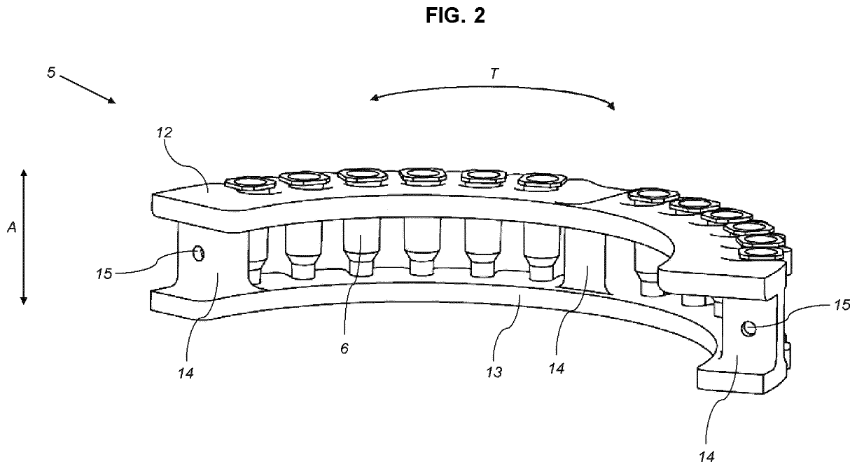

FIG. 2 a perspective view on a holder element holding wells,

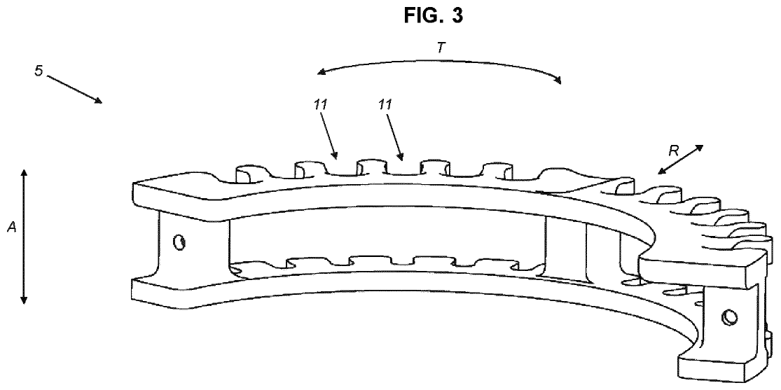

FIG. 3 a perspective view on the holder element without wells,

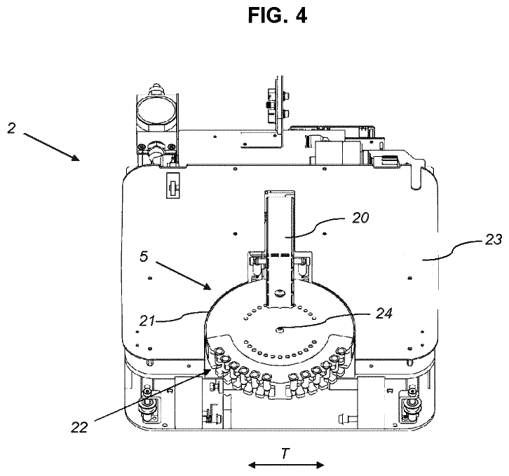

FIG. 4 a view on a part of the dispensing device with the well carrier device in its insertion position,

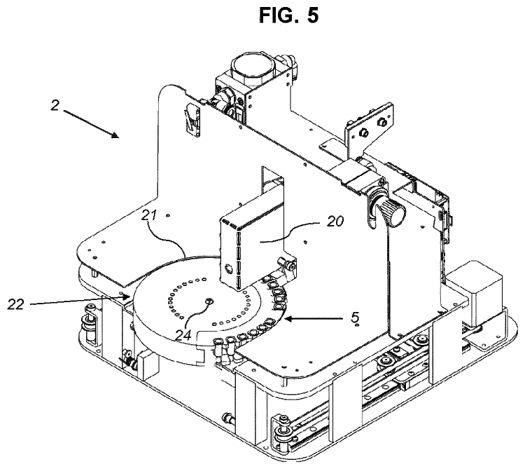

FIG. 5 a view on a part of the dispensing device with the well carrier device in its dispensing position.

FIG. 1 shows a well carrier device 1 for a dispensing device 2 shown in FIG. 5 wherein the well carrier device 1 is shown in a disassembled state. The well carrier device 1 comprises a well carrier 3 that comprises a coupling means 4 for connecting with rotating drive 24 shown in FIG. 4 of the dispensing device 2. The coupling means 4 is formed such that a connection in a rotationally fixed manner can be realized between the well carrier device 1 and the rotating drive. That means, the well carrier device 1 is rotated by means of the rotating drive 24.

Moreover, the well carrier device 1 comprises at least one holder element 5 for holding at least one well 6 for receiving a liquid sample. The holder element 5 is configured to hold twelve wells 6. However, other non-shown holder elements 5 can hold more or less than 12 wells. The holder element 5 is detachably connected to the well carrier 3. The wells 6 are arranged at the outer rim of the holder element 5.

The well carrier device 1 has a disc-shape and a circular cross section when the holder element 5 is connected with the well carrier 3. The well carrier 3 has a connecting portion 7. The connecting portion 7 is arranged at the outer rim of the well carrier 3 and extends in a circumferential direction of the well carrier 3. In particular, the connecting portion 7 extends about 170° in the circumferential direction of the well carrier 3.

At one end of the connecting portion 7 a magnet 8 is arranged. Likewise, a magnet 8 is arranged at another end of the connection portion 7. Lighting means 10 are arranged at a front face of the connecting portion 7. The lighting means 10 are arranged offset to each other in the circumferential direction of the well carrier 3. The magnets 8 are also arranged at the front face.

The extension of the connection portion 7 in axial direction is smaller than the extension of the remaining part of the well carrier 3. Thus, in an assembled state of the well carrier 3 an upper side of the well carrier 3 is flush with an upper side of the holder element 5. Additionally, an lower side of the well carrier 3 is flush with a lower side of the holder element 5 when the holder element 5 is connected with the well carrier 3.

The well carrier 3 comprises several openings 9 that are arranged offset to another in a tangential direction T. A fixing means of a dispensing head of the dispensing device is inserted into the opening 9 during a dispensing process in order to fix the well carrier device 1 in a predetermined position. Each of the openings 9 is assigned to one well 6. That means, the number of openings 9 corresponds to the number of holding portions 11 of the holder elements 5 which can hold a well 6, respectively.

The holder element 5 can be detached from the well carrier 3 by moving the holder element 5 along a radial direction R. Likewise, the holder element 5 can be connected to the well carrier 3 by moving the holder element 5 along the radial direction R wherein the direction is opposite to the radial direction R for detaching the holder element 5 from the well carrier 3.

FIG. 2 shows a perspective view on a holder element 5 holding wells 6 and FIG. 3 shows a perspective view on the holder element 5 without wells 6. The holder element 5 comprises an upper plate 12 and a lower plate 13 that are arranged offset to each other along an axial direction A. Additionally, the holder element 5 comprises three bars 14. The bar 14 is connected at one end with the lower plate 13 and at the other end with the upper plate 12.

The bars 14 are arranged offset to each other along the tangential direction T of the holder element 5 and/or are built identically. Thus, free space remains between the upper plate 12 and the lower plate 13. This enables that the wells 6 can be lightened by the lighting means 10 arranged at the connection portion 7.

The bars 14 that are arranged at the respective end of the holder element 5 comprises a magnet 15, respectively. The remaining bar 14 is arranged between the two bars 14 in the tangential direction T does not comprise a magnet. The magnets 15 are used to magnetically connect that holder element with the magnets 8 arranged in the connection portion of the well carrier 3.

As is seen from FIG. 3 the holder element 5 comprises several holding portions 11. Each of the holding portions 11 can hold one well 6. The holding portions 11 are arranged offset to each other along the tangential direction T of the holder element 5. The holding portions 11 are built such that the well 6 can be inserted by moving the well 6 along the axial direction A and/or the radial direction R. The holding portions 11 are formed by recesses formed in the upper plate 12 and the lower plate 12.

FIG. 4 shows a view on parts of the dispensing device 2 with the well carrier device 1 in its insertion position. In said position the holder element 5 can be connected to the well carrier 3 or detached from the well carrier 3.

The dispensing device 2 comprises a plate 23 with a receiving 21 in which the well carrier device 1 is inserted. The receiving 21 has a front opening 22. The front opening 22 is arranged in a non-shown housing of the dispensing device 2 and arranged such that the holder element 5 passes through said front opening 22 by its movement away from the well carrier 3 or to the well carrier 3. That means, the extension of the front opening 22 in tangential direction T is so broad that the holder element 5 can pass through it. Moreover, the dispensing device 2 comprises a dispensing head 20. The liquid sample located in the well 6 can be dispensed by the dispensing head 20.

FIG. 5 shows a view on a part of the dispensing device 2 with the well carrier device 1 in its dispensing position. In the dispensing position the well carrier device 1 is rotated by the rotating device 24 of the dispensing device 2 such that the dispensing head 20 can dispense liquid sample from the well 6 into a non-shown target carrier. In the dispensing position it is not possible to detach the holder element 5 from the well carrier 3.

### REFERENCE SIGNS

1 Well carrier device
2 Dispensing device
3 Well carrier
4 Coupling means
5 Holder element
6 Well
7 Connecting portion
8 Magnet in well carrier
9 Opening
10 Lighting means
11 Holding portion
12 Upper plate
13 Lower plate
14 Bar
15 Magnet in bar
20 Dispensing head
21 Receiving
22 Front opening
23 Plate
24 Rotating drive
A Axial direction
R Radial direction
T Tangential direction

1.-23. (canceled)

24. A well carrier device for a dispensing device for dispensing a liquid sample, with a well carrier that comprises a coupling that connects with a rotating drive of the dispensing device in a rotationally fixed manner, wherein the well carrier device comprises at least one well comprising a hole arranged at a well bottom and at least one holder element for holding the at least one well for receiving a liquid sample, wherein the holder element is detachably connected to the well carrier.

25. The well carrier device according to claim 24, wherein:
a. the well carrier device is disc shaped; and/or
b. the well carrier device has a circular shape in cross section; and/or
C. the connection between the carrier device and the holder element is configured such that the holder element can be detached tool free from the well carrier.

26. The well carrier device according to claim 24, wherein the well carrier has a connecting portion for connecting with the holder element, and wherein:
a. the connecting portion is arranged at an edge of the well carrier; and/or
b. the connecting portion extends along a part of a circumference of the well carrier;
and/or
c. an extension of the connecting portion in an axial direction is smaller than an extension of the remaining part of the well carrier in the axial direction.

27. The well carrier device according to claim 24, wherein the well carrier comprises at least one magnet for magnetically connecting the holder element to the well carrier.

28. The well carrier device according to claim 24, wherein the well carrier comprises at least one opening for receiving a fixing means of the dispensing device during a dispensing process.

29. The well carrier device according to claim 28, wherein a number of openings corresponds with a number of wells that can be attached to the holder element.

30. The well carrier device according to claim 24, wherein the well carrier comprises at least one light.

31. The well carrier device according to claim 30, wherein:
a. the light is arranged at a front face of a connecting portion; and/or
b. a number of lights corresponds with a number of wells that can be attached to the holder element; and/or
c. the light is arranged and/or orientated such that it lights the holder element.

32. The well carrier device according to claim 24, wherein the holder element is arc-shaped.

33. The well carrier device according to claim 24, wherein the holder element is formed such that it does not cover a well bottom.

34. The well carrier device according to claim 24, wherein:
a. the holder element has a holding portion for holding a well, wherein the holding portion is configured such that the well is insertable from an axial direction and/or a radial direction into the holding portion; and/or
b. the holder element has several holding portions wherein the holding portions are arranged offset to each other.

35. The well carrier device according to claim 24, wherein the holder element has an upper plate and a lower plate that are arranged offset to each other.

36. The well carrier device according to claim 35, wherein:
a. the upper plate and the lower plate are connected with each other by at least two bars; and/or
b. the upper plate and lower plate run parallel to each other.

37. The well carrier device according to claim 36, wherein the bar comprises at least one magnet for magnetically connecting the holder element to the well carrier.

38. The well carrier device according claim 24, wherein:
a. in a connected state of the holder element with the well carrier, an upper side of the holder element is flush with an upper side of the well carrier and/or a lower side of the holder element is flush with a lower side of the well carrier; and/or
b. the holder element is formed such that it is connectable with the well carrier by moving it in radial direction.

39. A dispensing device for dispensing a liquid sample, with a well carrier device according to claim 24, a rotating drive that is connected with the well carrier device in a rotationally fixed manner and a dispensing head for dispensing liquid sample located in a well of the well carrier device.

40. The dispensing device according to claim 39, wherein the dispensing device has a plate with a receiving comprising a front opening, wherein the well carrier device is arranged in the receiving and protrudes from the front opening.

41. The dispensing device according to claim 39, wherein the dispensing device comprises a control unit that controls the rotating drive such that the well carrier device is rotated in at least one of an insertion position, in which the holder element can be removed from the well carrier or connected with the well carrier, a dispensing position in which the liquid is dispensed from the well, or a parking position.

42. The dispensing device according to claim 39, wherein:
a. the dispensing device comprises a fixing means which protrudes in an opening of the well carrier during a dispensing process; and/or
b. the holder element is connectable to the well carrier or detachable from the well carrier when the well carrier is arranged in the receiving of the dispensing device.
